(19) United States
(12) Patent Application Publication
(10) Pub. No.: US 2026/0046718 A1
(43) Pub. Date: Feb. 12, 2026

(54) DYNAMIC CHANNEL ADAPTATION DURING PACKET CAPTURE IN A WIRELESS NETWORK

(71) Applicant: Charter Communications Operating, LLC, St. Louis, MO (US)

(72) Inventor: Sagar Indrajitbhai Panchal, Denver, CO (US)

(21) Appl. No.: 18/799,519

(22) Filed: Aug. 9, 2024

(51) Int. Cl. H04W 36/08; H04W 72/0453

(52) U.S. Cl. CPC H04W 36/08; H04W 72/0453

(57) ABSTRACT

A computing device that includes a wireless transceiver operable to receive communications on a designated wireless frequency obtains a first wireless frequency identifier that corresponds to a first wireless frequency being used by a user equipment (UE) to wirelessly communicate with a first wireless access point (AP). The computing device sends instructions to the wireless transceiver to set the designated wireless frequency to the first wireless frequency. The computing device determines that the UE switched from using the first wireless frequency to using a second wireless frequency to communicate with a second AP. The computing device, in response to determining that the UE switched from using the first wireless frequency to using the second wireless frequency, sends instructions to the wireless transceiver to set the designated wireless frequency to the second wireless frequency.

### BACKGROUND

A packet capture tool is often used to capture packets communicated between two devices. The packets, and metadata associated with the packets, may be used to diagnose and resolve problems.

### SUMMARY

The examples disclosed herein implement dynamic channel adaptation during packet capture in a wireless network.

In one implementation a method is provided. The method includes obtaining, by a computing device comprising a wireless transceiver operable to receive communications on a designated wireless frequency, a first wireless frequency identifier that corresponds to a first wireless frequency being used by a user equipment (UE) to wirelessly communicate with a first wireless access point (AP). The method further includes sending, by the computing device, instructions to the wireless transceiver to set the designated wireless frequency to the first wireless frequency. The method further includes determining, by the computing device, that the UE switched from using the first wireless frequency to using a second wireless frequency to communicate with a second AP. The method further includes, in response to determining that the UE switched from using the first wireless frequency to using the second wireless frequency, sending, by the computing device, instructions to the wireless transceiver to set the designated wireless frequency to the second wireless frequency.

In another implementation a computing device is provided. The computing device includes a memory, a wireless transceiver operable to receive communications on a designated wireless frequency, and a processor device coupled to the memory and being operable to obtain a first wireless frequency identifier that corresponds to a first wireless frequency being used by a user equipment (UE) to wirelessly communicate with a first wireless access point (AP). The processor device is further operable to send instructions to the wireless transceiver to set the designated wireless frequency to the first wireless frequency. The processor device is further operable to determine that the UE switched from using the first wireless frequency to using a second wireless frequency to communicate with a second AP. The processor device is further operable to, in response to determining that the UE switched from using the first wireless frequency to using the second wireless frequency, send instructions to the wireless transceiver to set the designated wireless frequency to the second wireless frequency.

In another implementation a non-transitory computer-readable storage medium is provided. The non-transitory computer-readable storage medium includes executable instructions to cause one or more processor devices coupled to a wireless transceiver operable to receive communications on a designated wireless frequency to obtain a first wireless frequency identifier that corresponds to a first wireless frequency being used by a user equipment (UE) to wirelessly communicate with a first wireless access point (AP). The instructions further cause the one or more processor devices to send instructions to the wireless transceiver to set the designated wireless frequency to the first wireless frequency. The instructions further cause the one or more processor devices to determine that the UE switched from using the first wireless frequency to using a second wireless frequency to communicate with a second AP. The instructions further cause the one or more processor devices to, in response to determining that the UE switched from using the first wireless frequency to using the second wireless frequency, send instructions to the wireless transceiver to set the designated wireless frequency to the second wireless frequency.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which dynamic channel adaptation during packet capture in a wireless network can be practiced according to some implementations;

FIG. 2 is a flowchart of a method for dynamic channel adaptation during packet capture in a wireless network according to some implementations;

FIGS. 3A-3B illustrate a sequence diagram showing messages communicated between and actions taken by various components illustrated in FIG. 1 to implement dynamic channel adaptation during packet capture in a wireless network according to some examples; and

FIG. 4 is a block diagram of the computing device 28 suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

When user equipment (UE), such as a wireless mobile device, communicates with a wireless access point (AP), the UE and AP establish a particular channel via which the UE and AP will communicate. The channel is implemented over a particular frequency. 2.4 GHz Wi-Fi (e.g., IEEE 802.11b) implements eleven channels that can be used, 5 GHz Wi-Fi (e.g., IEEE 802.11b) implements twenty-four potential channels that can be used, 6 GHz Wi-Fi (e.g., IEEE 802.11ax and 802.11be) has fifty-nine channels of 20 MHz bandwidth, twenty-nine 40 MHz channels, fourteen 80 MHz channels, and seven 160 MHz channels. Within the particular Wi-Fi technology being used, a channel number corresponds to a particular frequency. For example, in 2.4 GHz Wi-Fi, channel 1 corresponds to a frequency of 2412 MHz. The frequency is a center frequency of a frequency range.

To diagnose wireless communications problems a packet capture tool may be run on a mobile device capable of receiving packets communicated between a UE and an AP on a particular frequency. The packet capture tool can set the wireless transceiver of the mobile device to a desired frequency (i.e., channel) and receive and store packets communicated on that particular frequency. The packets and metadata may be stored and subsequently analyzed to aid in diagnosing a problem.

Sometimes problems arise when a UE transitions from one AP to another AP. Such transitions occur when the UE moves from a coverage area serviced by one AP to a coverage area serviced by an adjacent AP. For example, a facility may install a plurality of APs in a large building. As a user who is using a UE that is connected to a first wireless AP moves from one location in the building to another location in the building, the UE may eventually connect to a second AP that, due to the change in location of the UE, has a stronger signal than the first wireless AP to which the UE was previously connected.

Diagnosing such connection issues can be difficult because the second AP may establish and utilize a different frequency (e.g., channel) to communicate with the UE than the first wireless AP. A packet capturing tool that is capturing the packets communicated between the UE and the first wireless AP has no knowledge that the UE has now transitioned from using one frequency to another frequency, and can no longer capture the packets between the UE and the second AP. Those packets, however, may be the packets necessary to successfully diagnose the connection problem.

The examples disclosed herein implement dynamic channel adaptation during packet capture in a wireless network. A computing device determines that a UE is wirelessly communicating with an AP on a first frequency. The computing device sets a wireless transceiver of the computing device to receive packets transmitted on the first frequency. The computing device receives and stores packets received on the first frequency. The computing device determines that the UE switched from using the first frequency to using a second wireless frequency. The computing device sets the wireless transceiver to receive packets transmitted on the second frequency. The computing device receives and stores packets received on the second frequency. The implementations disclosed herein facilitate diagnosing and resolving problems associated with wireless transmissions by ensuring complete packet capture between a UE and one or more APs, even as the UE moves from AP to AP and from frequency to frequency.

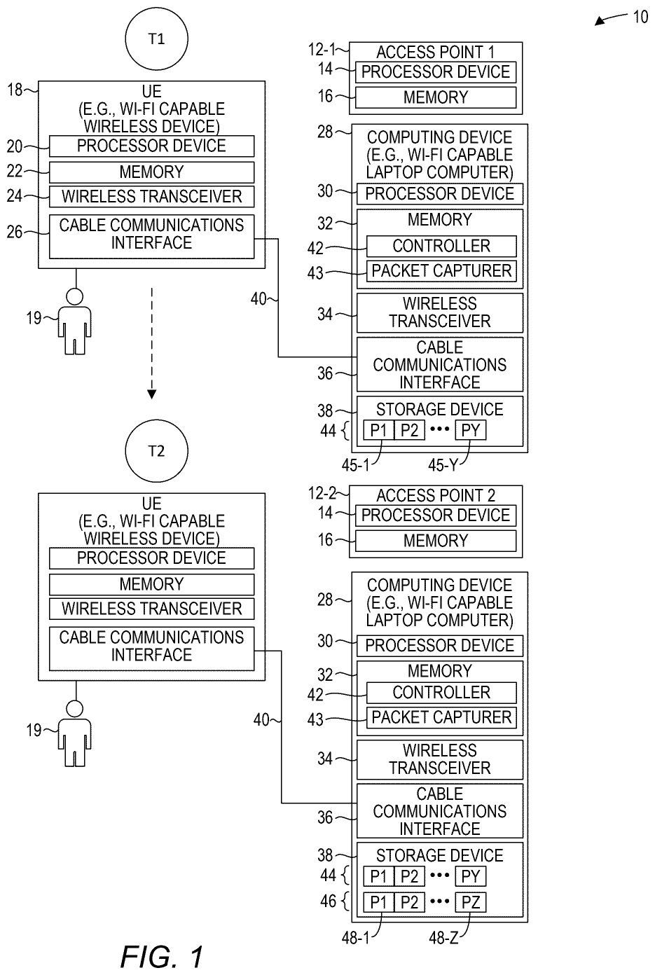

FIG. 1 is a block diagram of an environment 10 in which dynamic channel adaptation during packet capture in a wireless network can be practiced according to some implementations. The environment 10 includes an AP 12-1 and an AP 12-2, each of which implements a wireless local area network, such as a Wi-Fi wireless network, using, by way of non-limiting example, one or more of 2.4 GHZ, 5 GHZ, and 6 GHz Wi-Fi technologies. While not illustrated, the APs 12-1 and 12-2 are communicatively coupled to upstream computing devices and facilitate communications between such upstream computing devices, such as web servers on the Internet or content streaming services, and local wireless devices that connect to the APs 12-1 and 12-2 wirelessly.

The APs 12-1 and 12-2 may broadcast the same service set identifier (SSID) or different SSIDs. Where the APs 12-1 and 12-2 broadcast the same SSID, it may be considered that collectively they implement a single wireless network. Where the APs 12-1 and 12-2 broadcast different SSIDs, it may be considered that they each implement a different wireless network. The implementations disclosed herein operate substantially similarly in either situation.

The environment 10 includes a UE 18 and a user 19 of the UE 18. The UE 18 is a mobile device and includes a processor device 20, a memory 22 a wireless transceiver 24 and in this example, a cable communications interface 26. The UE 18 may comprise, for example, a smartphone, a laptop computer, a computing tablet, or any other mobile/portable computing device with wireless capabilities.

The environment 10 includes a computing device 28. The computing device 28 is also a mobile device and includes a processor device 30, a memory 32, a wireless transceiver 34, a cable communications interface 36 and a storage device 38. The computing device 28 is capable of communicating with the UE 18 independent of the wireless transceiver 24. As examples, the computing device 28 may be able to establish a connection with the UE 18 via Bluetooth or Zigbee wireless technologies. In this example, the computing device 28 establishes a connection with the UE 18 via a cable 40 connected to the cable communications interface 26 and the cable communications interface 36. The exact type of the cable 40 may differ depending on the UE 18 and the computing device 28. For example, if the UE 18 is laptop computer, the cable 40 may comprise a USB-A to USB-A cable. If the UE 18 is an Apple® iPhone®, the cable 40 may comprise a USB-A to Lightning cable, or a USB-A to USB-C cable. If the UE 18 is an Android® smartphone the cable 40 may comprise a USB-A to USB Micro cable. It is noted that these are simply examples of cable connections between the UE 18 and the computing device 28, and any suitable cable that can be connected to the UE 18 and the computing device 28 that facilitates communication can be used.

At a time T1, the UE 18 establishes a connection to the AP 12-1. During the connection process, the AP 12-1 and the UE 18 establish a particular frequency via which the AP 12-1 and the UE 18 will communicate with one another. The computing device 28 can obtain the frequency information, such as a frequency identifier that identifies the frequency or the channel from the UE 18. In some implementations, such as where the UE 18 is an Android-based device, the UE 18 may be set to a debugging mode wherein the UE 18 stores information in a data structure that includes the frequency on which the UE 18 communicates with the AP 12-1. The terms “on”, “over” and “via” are synonymous as used herein when discussing communications “on”, “over” or “via” a particular frequency. Each such term refers to the use of a particular frequency by the UE 18 and the AP 12-1 to communicate with one another.

The computing device 28 includes a controller 42 that iteratively obtains, via the cable 40, a frequency identifier that identifies the current wireless frequency (e.g., a first wireless frequency) being used by the UE 18. The wireless transceiver 34 has a plurality of operating modes, including, by way of non-limiting example, a monitor operating mode (e.g., monitor mode) during which the wireless transceiver 34 can receive packets being communicated between two other devices, such as the UE 18 and the AP 12-1, over a particular frequency. The controller 42 sets the wireless transceiver 34 to monitor mode, and sets the wireless transceiver 34 to receive packets transmitted on the first wireless frequency being used by the UE 18 to communicate with the AP 12-1. In some implementations, the frequency may be converted to the particular channel to which the frequency corresponds, and the controller 42 sets the wireless transceiver 34 to receive packets transmitted on the first wireless frequency by setting the wireless transceiver 34 to receive packets transmitted on the corresponding channel.

The UE 18 and the AP 12-1 communicate packets over the first wireless frequency. For example, the UE 18 may request a web page from an Internet web server. The request is packetized (e.g., TCP/IP packets) and communicated to the AP 12-1 over the first wireless frequency, and from the AP 12-1 ultimately to the destination web server. A response from the web server is communicated to the AP 12-1 and then wirelessly communicated from the AP 12-1 to the UE 18 over the first wireless frequency. The computing device 28 receives each of the packets communicated between the UE 18 and the AP 12-1 on the first wireless frequency. In one implementation the controller 42 may receive and store the packets. In another implementation, such as illustrated in FIG. 1, a packet capturer 43 receives the packets and stores the packets as a first set 44 of packets 45-1-45-Y (generally, packets 45) on the storage device 38. The number of packets 45 may be hundreds, thousands, or more. The packet capturer 43 may comprise any suitable packet capture tool, such as, by way of non-limiting example, Wireshark, available at www.wireshark.org. Alternatively, the packet capturer 43 may comprise an operating system tool, such as tcpdump, or the like.

In this example the controller 42 iteratively retrieves, from the UE 18 via the cable 40, frequency information that includes a frequency identifier (ID) that identifies the current frequency used by the UE 18 to communicate with the AP 12-1. In other implementations the frequency ID may identify the corresponding channel number. The controller 42 compares the frequency ID to the frequency ID obtained in the previous iteration to determine whether the UE 18 has switched to a different frequency (i.e., channel). The computing device 28 may obtain the frequency information at any suitable interval, such as 10 milliseconds (ms), 50 ms, 100 ms, or the like.

The user 19 is mobile and at a time T2 moves the UE 18 and the computing device 28 within a range of the AP 12-2 such that the UE 18 decides to transition (e.g., switch) from the AP 12-1 to the AP 12-2. During the connection process, the AP 12-2 and the UE 18 establish a particular frequency (i.e., channel) via which the AP 12-2 and the UE 18 will communicate with one another. The frequency (e.g., second frequency) is a different frequency than the first frequency. The controller 42 retrieves, from the UE 18 via the cable 40, the frequency information that includes the frequency ID that identifies the current frequency used by the UE 18 to communicate with the AP 12-2. The computing device 28 determines that the wireless frequency that the UE 18 is using to wirelessly communicate with the AP 12-2 is different from the first wireless frequency that the UE 18 was using to wirelessly communicate with the AP 12-1 in the immediately preceding iteration.

The controller 42 sets the wireless transceiver 34 to receive packets transmitted on the second wireless frequency being used by the UE 18 to communicate with the AP 12-2. The computing device 28 receives each of the packets communicated between the UE 18 and the AP 12-2 on the second wireless frequency, and the packet capturer 43 stores the packets as a second set 46 of packets 48-1-48-Z (generally, packets 48) on the storage device 38. The number of packets 48 may be hundreds, thousands, or more. In this manner, the controller 42 causes the packet capturer 43 to capture each of the packets communicated between the UE 18 and the AP 12-1 and between the UE 18 and the AP 12-2 as the UE 18 transitioned from the AP 12-1 to the AP 12-2. Such packets may be subsequently analyzed to diagnose and resolve problems that arose during the transition process.

It is noted that, because the controller 42 is a component of the computing device 28, functionality implemented by the controller 42 may be attributed to the computing device 28 generally. Moreover, in examples where the controller 42 comprises software instructions that program the processor device 30 to carry out functionality discussed herein, functionality implemented by the controller 42 may be attributed herein to the processor device 30.

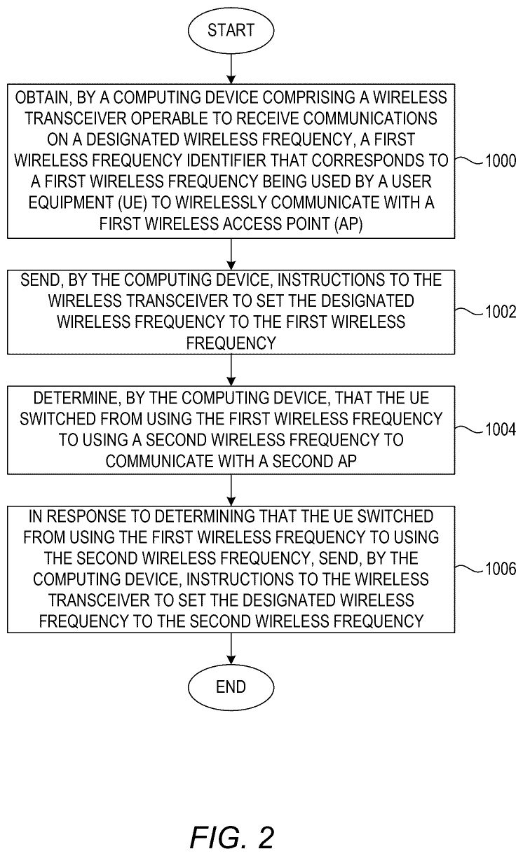

FIG. 2 is a flowchart of a method for dynamic channel adaptation during packet capture in a wireless network according to some implementations. FIG. 2 will be discussed in conjunction with FIG. 1. The computing device 28 obtains the first wireless frequency ID that corresponds to the first wireless frequency being used by the UE 18 to wirelessly communicate with the first wireless AP 12-1 (FIG. 2, block 1000). The computing device 28 sends instructions to the wireless transceiver 34 to set the designated wireless frequency to the first wireless frequency (FIG. 2, block 1002). The computing device 28 determines that the UE 18 switched from using the first wireless frequency to using a second wireless frequency to communicate with the second AP 12-2 (FIG. 2, block 1004). In response to determining that the UE 18 switched from using the first wireless frequency to using the second wireless frequency, the computing device 28 sends instructions to the wireless transceiver 34 to set the designated wireless frequency to the second wireless frequency (FIG. 2, block 1006).

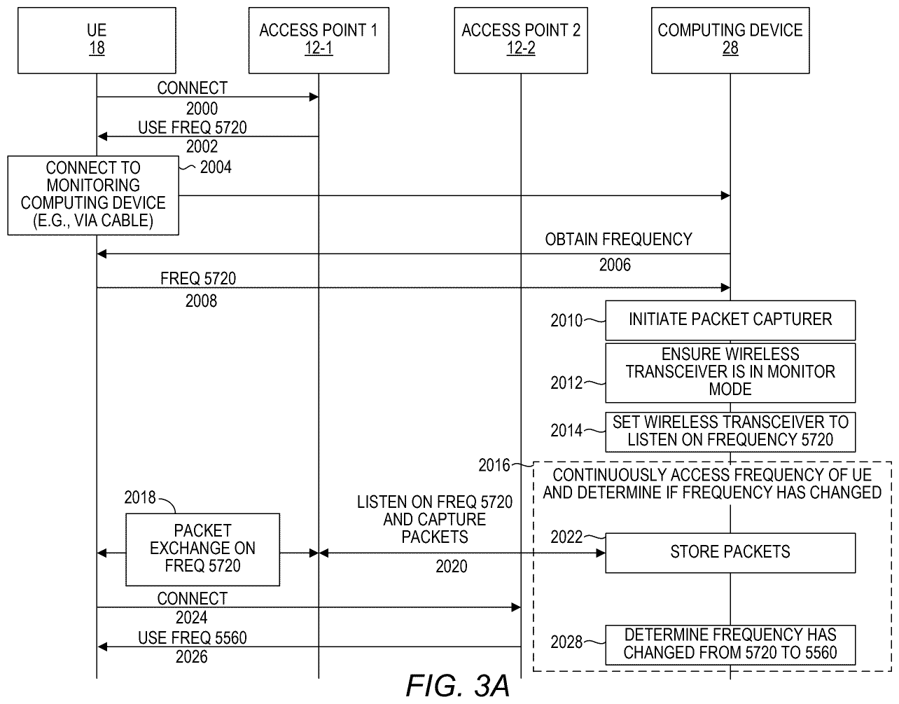

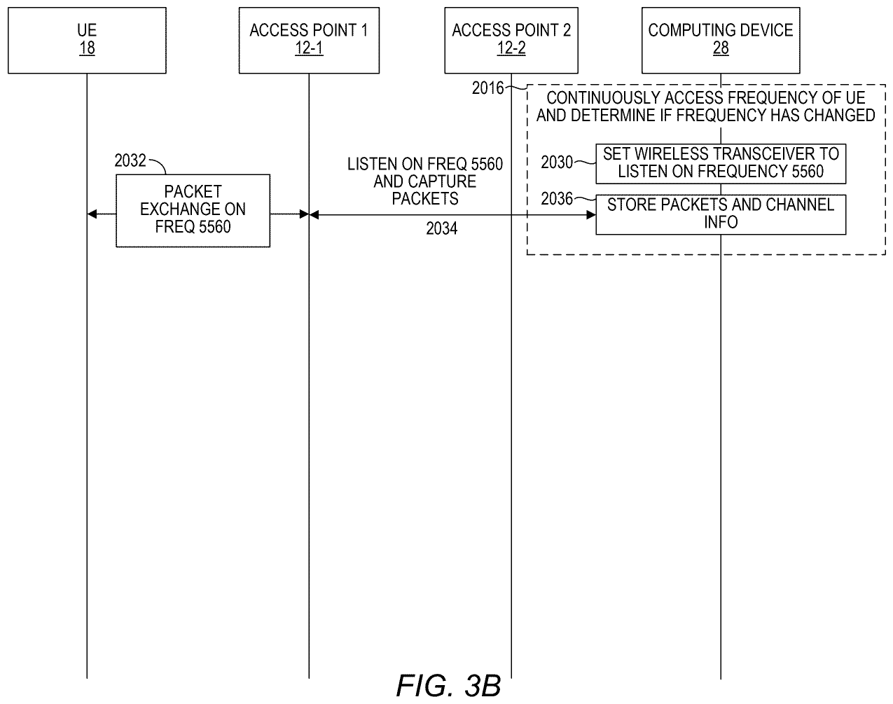

FIGS. 3A-3B illustrate a sequence diagram showing messages communicated between and actions taken by various components illustrated in FIG. 1 to implement dynamic channel adaptation during packet capture in a wireless network according to some examples. Referring first to FIG. 3A, the UE 18 initiates a connection with the AP 12-1 (FIG. 3A, step 2000). During the connection process the UE 18 or the AP 12-1 makes a determination to use a particular frequency, or channel, in this example, 5720 MHz which corresponds to channel 144 in the 5 GHz wireless local area network technologies published in IEEE 802.11a/h/n/ac/ax/be (FIG. 3A, step 2002). The UE 18 connects to the computing device 28 via a communications path other than the wireless frequency used by the UE 18 to connect to the AP 12-1 (FIG. 3A, step 2004). In this example, the UE 18 connects to the computing device 28 via the cable 40.

The computing device 28 obtains a frequency ID from the UE 18 that corresponds to the frequency 5720 MHz (FIG. 3A, blocks 2006, 2008). The frequency ID may identify the frequency, or may identify the channel to which the frequency corresponds. In some implementations, such as where the UE 18 is an Android-based device, the UE 18 may be set to a debugging mode wherein the UE 18 stores information in a data structure that includes the current frequency on which the UE 18 is communicating with an AP. The computing device 28 may then query the UE 18 for the frequency ID. In other implementations, the UE 18 may initiate a frequency agent process that is operable to communicate with the controller 42 executing on the computing device 28. In particular, the controller 42 may send a request to provide the current frequency on which the UE 18 is communicating with the AP 12-1. The frequency agent process accesses the wireless transceiver information of the UE 18, obtains the current frequency, and sends the current frequency to the controller 42.

The packet capturer 43 is initiated on the computing device 28 (FIG. 3A, step 2010). The packet capturer 43 may be initiated manually, or the controller 42 may automatically initiate the packet capturer 43. In some implementations, the controller 42 may include the packet capturer 43 and thus the packet capturer 43 need not be separately initiated. Where the packet capturer 43 is separate from the controller 42, the packet capturer 43 may comprise any suitable packet capturing technology, by way of non-limiting example, Wireshark, tcpdump, or the like. The packet capturer 43 is operable to obtain packets received by the wireless transceiver 34 and store such packets on the storage device 38. The packet capturer 43 may also include user interface capabilities and be operable to provide information about the packets in real-time on a display device of the computing device 28. It is noted that the sequence of steps illustrated herein is simply one example and the sequence of steps may differ in other examples. For example, the packet capturer 43 may be initiated prior to the initiation of the controller 42, and even prior to the UE 18 connecting to the AP 12-1.

The controller 42 ensures that the wireless transceiver 34 is in monitor mode (FIG. 3A, step 2012). The controller 42 may query the wireless transceiver 34 to determine the current operating mode, and if the wireless transceiver 34 is not currently in monitor mode, sets the wireless transceiver 34 to be in monitor mode. Alternatively, the controller 42 may simply set the wireless transceiver 34 to be in monitor mode without first querying the wireless transceiver 34. The controller 42 sets the wireless transceiver 34 to the designated frequency, in this example, 5720 MHz (FIG. 3A, step 2014). In some implementations, the wireless transceiver 34 may be configured to utilize channel numbers rather than frequency numbers in order to tune to the appropriate frequency. In such implementations, the controller 42 converts the frequency to the corresponding channel, and sets the wireless transceiver 34 to the designated frequency by utilizing the channel number. Table 1 illustrates example pseudocode programming instructions suitable for converting a frequency to a corresponding channel number.

TABLE 1

```
#1 # Dictionary mapping frequencies to channels
# (Start, Center): Channel number
(2401, 2412): 1
(2406, 2417): 2
(2411, 2422): 3
(2416, 2427): 4
(2421, 2432): 5
(2426, 2437): 6
(2431, 2442): 7
(2436, 2447): 8
(2441, 2452): 9
(2446, 2457): 10
(2451, 2462): 11
(5170, 5180): 36
(5190, 5200): 40
(5210, 5220): 44
(5230, 5240): 48
(5250, 5260): 52
(5270, 5280): 56
(5290, 5300): 60
(5310, 5320): 64
(5490, 5500): 100
(5510, 5520): 104
(5530, 5540): 108
(5550, 5560): 112
(5570, 5580): 116
(5590, 5600): 120
(5610, 5620): 124
(5630, 5640): 128
(5650, 5660): 132
(5670, 5680): 136
(5690, 5700): 140
(5710, 5720): 144
(5735, 5745): 149
(5755, 5765): 153
(5775, 5785): 157
(5795, 5805): 161
(5815, 5825): 165
#2 Function to convert frequency to channel
def convert_to_channel(frequency):
  for freq_range, channel in frequency_to_channel.items( ):
    if frequency in freq_range:
      return channel
  return “Unknown frequency”
# 5 Convert frequency to channel
    channel = convert_to_channel(frequency)
```

The computing device 28 continuously, such as every 10 milliseconds (ms), 50 ms, 100 ms, or any other suitable period of time, obtains the current frequency ID that corresponds to the frequency being used by the UE 18 to wirelessly communicate, and compares the frequency ID to the previous current frequency ID that was obtained (FIG. 3A, step 2016). The UE 18 and the AP 12-1 exchange packets, such as TCP/IP packets, for a period of time (FIG. 3A, step 2018). The packet capturer 43 obtains the packets exchanged between the UE 18 and the AP 12-1 and received by the wireless transceiver 34 on the frequency 5720 MHz, and stores the packets as the first set 44 of packets 45-1-45-Y on the storage device 38 (FIG. 3A, steps 2020, 2022).

The user 19 moves the UE 18 sufficiently close to the AP 12-2 that the UE 18 decides to switch from the AP 12-1 to the AP 12-2. The UE 18 initiates a connection with the AP 12-2 (FIG. 3A, step 2024). During the connection process the UE 18 or the AP 12-2 makes a determination to use a particular frequency, or channel, in this example, 5560 MHz which corresponds to channel 112 in the 5 GHz wireless local area network technology (FIG. 3A, step 2026).

The computing device 28 obtains the frequency ID from the UE 18 and determines that the frequency ID has changed from the frequency ID previously obtained from the UE 18 (FIG. 3A, step 2028). Referring now to FIG. 3B, the controller 42 sets the wireless transceiver 34 to the designated frequency, in this example, 5560 MHz (FIG. 3B, step 2030). The UE 18 and the AP 12-2 exchange packets, such as TCP/IP packets, for a period of time (FIG. 3B, step 2032). The packet capturer 43 obtains the packets exchanged between the UE 18 and the AP 12-2 and received by the wireless transceiver 34 on the frequency 5560 MHz, and stores the packets as the second set 46 of packets 48-1-48-Z on the storage device 38 (FIG. 3B, steps 2034, 2036).

In this manner, the controller 42 causes the packet capturer 43 to capture each of the packets communicated between the UE 18 and the AP 12-1 and between the UE 18 and the AP 12-2 before, during and after the UE 18 transitioned from the AP 12-1 to the AP 12-2. Such packets may be subsequently analyzed to diagnose and resolve problems that arose during the transition process.

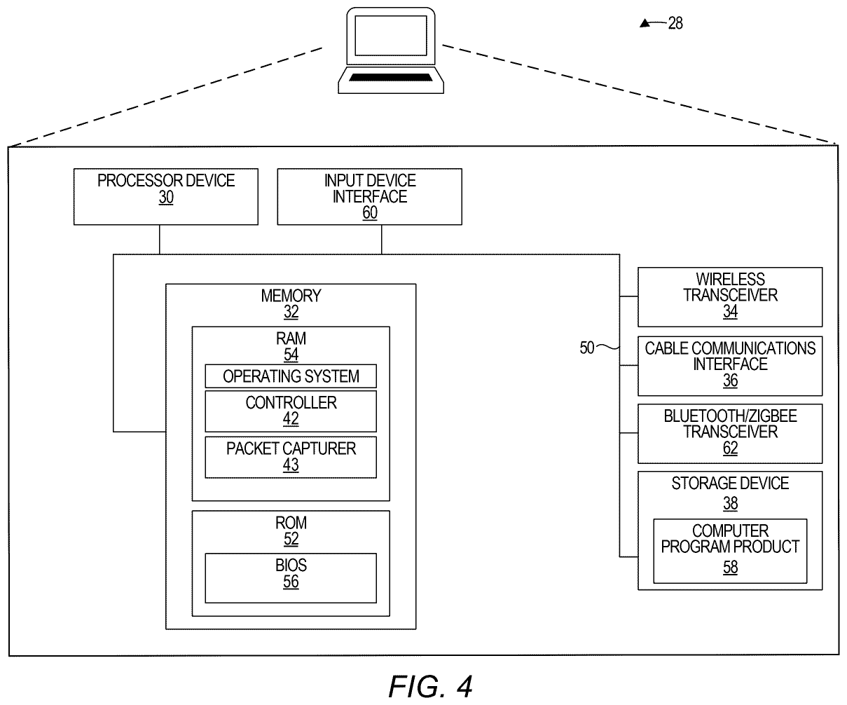

FIG. 4 is a block diagram of the computing device 28 suitable for implementing examples disclosed herein. The computing device 28 may comprise any computing or electronic device capable of including firmware, hardware, and/or executing software instructions to implement the functionality described herein, such as a laptop computing device, a smartphone, a computing tablet, or the like. The computing device 28 includes the processor device 30, the system memory 32, and a system bus 50. The system bus 50 provides an interface for system components including, but not limited to, the system memory 32 and the processor device 30. The processor device 30 can be any commercially available or proprietary processor.

The system bus 50 may be any of several types of bus structures that may further interconnect to a memory bus (with or without a memory controller), a peripheral bus, and/or a local bus using any of a variety of commercially available bus architectures. The system memory 32 may include non-volatile memory 52 (e.g., read-only memory (ROM), erasable programmable read-only memory (EPROM), electrically erasable programmable read-only memory (EEPROM), etc.), and volatile memory 54 (e.g., random-access memory (RAM)). A basic input/output system (BIOS) 56 may be stored in the non-volatile memory 52 and can include the basic routines that help to transfer information between elements within the computing device 28. The volatile memory 54 may also include a high-speed RAM, such as static RAM, for caching data.

The computing device 28 may further include or be coupled to a non-transitory computer-readable storage medium such as the storage device 38, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 38 and other drives associated with computer-readable media and computer-usable media may provide non-volatile storage of data, data structures, computer-executable instructions, and the like.

A number of modules can be stored in the storage device 38 and in the volatile memory 54, including an operating system and one or more program modules, such as the controller 42, which may implement the functionality described herein in whole or in part. All or a portion of the examples may be implemented as a computer program product 58 stored on a transitory or non-transitory computer-usable or computer-readable storage medium, such as the storage device 38, which includes complex programming instructions, such as complex computer-readable program code, to cause the processor device 30 to carry out the steps described herein. Thus, the computer-readable program code can comprise software instructions for implementing the functionality of the examples described herein when executed on the processor device 30. The processor device 30, in conjunction with the controller 42 in the volatile memory 54, may serve as a controller, or control system, for the computing device 28 that is to implement the functionality described herein.

An operator, such as the user 19, may also be able to enter one or more configuration commands through a keyboard (not illustrated), a pointing device such as a mouse (not illustrated), or a touch-sensitive surface such as a display device. Such input devices may be connected to the processor device 30 through an input device interface 60 that is coupled to the system bus 50 but can be connected by other interfaces such as a parallel port, an Institute of Electrical and Electronic Engineers (IEEE) 1394 serial port, a Universal Serial Bus (USB) port, an IR interface, and the like. The computing device 28 includes the wireless transceiver 34 and the cable communications interface 36. The computing device 28 may also include one or more additional transceivers, such as a wired Ethernet transceiver (not illustrated), and other wireless transceivers such as a Bluetooth and/or a Zigbee transceiver 62 operable to establish a connection to the UE 18.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing device comprising a wireless transceiver operable to receive communications on a designated wireless frequency, a first wireless frequency identifier that corresponds to a first wireless frequency being used by a user equipment (UE) to wirelessly communicate with a first wireless access point (AP);
sending, by the computing device, instructions to the wireless transceiver to set the designated wireless frequency to the first wireless frequency;
determining, by the computing device, that the UE switched from using the first wireless frequency to using a second wireless frequency to communicate with a second AP; and
in response to determining that the UE switched from using the first wireless frequency to using the second wireless frequency, sending, by the computing device, instructions to the wireless transceiver to set the designated wireless frequency to the second wireless frequency.

2. The method of claim 1, further comprising ensuring, by the computing device, that the wireless transceiver is in a monitor mode, wherein when in the monitor mode the wireless transceiver operates to receive packets communicated on the designated wireless frequency.

3. The method of claim 2, wherein in the monitor mode, the wireless transceiver operates to receive packets communicated on the designated wireless frequency irrespective of a source address or a destination address of the packets.

4. The method of claim 1, further comprising:
causing, by the computing device, a first set of packets received on the first wireless frequency to be stored.

5. The method of claim 1, further comprising:
causing, by the computing device, a second set of packets received on the second wireless frequency to be stored.

6. The method of claim 1, further comprising:
prior to obtaining the first wireless frequency identifier, establishing, by the computing device with the UE, a connection via a cable coupled to the computing device and the UE.

7. The method of claim 6, wherein obtaining the first wireless frequency identifier that corresponds to the first wireless frequency being used by the UE to wirelessly communicate with the first wireless AP further comprises obtaining, by the computing device from the UE via the cable, the first wireless frequency identifier that corresponds to the first wireless frequency being used by the UE to wirelessly communicate with the first wireless AP.

8. The method of claim 1, further comprising:
prior to obtaining the first wireless frequency identifier, establishing, by the computing device a wireless connection with the UE.

9. The method of claim 8, wherein obtaining the first wireless frequency identifier that corresponds to the first wireless frequency being used by the UE to wirelessly communicate with the first wireless AP further comprises obtaining, by the computing device from the UE via the wireless connection, the first wireless frequency identifier that corresponds to the first wireless frequency being used by the UE to wirelessly communicate with the first wireless AP.

10. The method of claim 1, wherein determining, by the computing device, that the UE switched from using the first wireless frequency to using the second wireless frequency further comprises:
iteratively:
obtaining wireless frequency information from the UE that corresponds to a wireless frequency that the UE is using to wirelessly communicate with any AP; and
determining that the wireless frequency that the UE is using to wirelessly communicate with any AP is different from a wireless frequency that the UE was using to wirelessly communicate with any AP in an immediately preceding iteration.

11. A computing device, comprising:
a memory;
a wireless transceiver operable to receive communications on a designated wireless frequency; and
a processor device coupled to the memory and the wireless transceiver and being operable to:
obtain a first wireless frequency identifier that corresponds to a first wireless frequency being used by a user equipment (UE) to wirelessly communicate with a first wireless access point (AP);
send instructions to the wireless transceiver to set the designated wireless frequency to the first wireless frequency;
determine that the UE switched from using the first wireless frequency to using a second wireless frequency to communicate with a second AP; and
in response to determining that the UE switched from using the first wireless frequency to using the second wireless frequency, send instructions to the wireless transceiver to set the designated wireless frequency to the second wireless frequency.

12. The computing device of claim 11, wherein the processor device is further operable to ensure that the wireless transceiver is in a monitor mode, wherein when in the monitor mode the wireless transceiver operates to receive packets communicated on the designated wireless frequency.

13. The computing device of claim 11, wherein the processor device is further operable to:
prior to obtaining the first wireless frequency identifier, establish, with the UE, a connection via a cable coupled to the computing device and the UE.

14. The computing device of claim 13, wherein to obtain the first wireless frequency identifier that corresponds to the first wireless frequency being used by the UE to wirelessly communicate with the first wireless AP, the processor device is further operable to obtain, from the UE via the cable, the first wireless frequency identifier that corresponds to the first wireless frequency being used by the UE to wirelessly communicate with the first wireless AP.

15. The computing device of claim 11, wherein to determine that the UE switched from using the first wireless frequency to using the second wireless frequency, the processor device is further operable to:
iteratively:
obtain wireless frequency information from the UE that corresponds to a wireless frequency that the UE is using to wirelessly communicate with any AP; and
determine that the wireless frequency that the UE is using to wirelessly communicate with any AP is different from a wireless frequency that the UE was using to wirelessly communicate with any AP in an immediately preceding iteration.

16. A non-transitory computer-readable storage medium that includes executable instructions to cause one or more processor devices of a computing device that includes a wireless transceiver operable to receive communications on a designated wireless frequency to:
obtain a first wireless frequency identifier that corresponds to a first wireless frequency being used by a user equipment (UE) to wirelessly communicate with a first wireless access point (AP);
send instructions to the wireless transceiver to set the designated wireless frequency to the first wireless frequency;
determine that the UE switched from using the first wireless frequency to using a second wireless frequency to communicate with a second AP; and
in response to determining that the UE switched from using the first wireless frequency to using the second wireless frequency, send instructions to the wireless transceiver to set the designated wireless frequency to the second wireless frequency.

17. The non-transitory computer-readable storage medium of claim 16, wherein the instructions are further operable to cause the one or more processor devices to ensure that the wireless transceiver is in a monitor mode, wherein when in the monitor mode the wireless transceiver operates to receive packets communicated on the designated wireless frequency.

18. The non-transitory computer-readable storage medium of claim 16, wherein the instructions are further operable to cause the one or more processor devices to:
prior to obtaining the first wireless frequency identifier, establish, with the UE, a connection via a cable coupled to the computing device and the UE.

19. The non-transitory computer-readable storage medium of claim 18, wherein to obtain the first wireless frequency identifier that corresponds to the first wireless frequency being used by the UE to wirelessly communicate with the first wireless AP, the instructions are further operable to cause the one or more processor devices to obtain, from the UE via the cable, the first wireless frequency identifier that corresponds to the first wireless frequency being used by the UE to wirelessly communicate with the first wireless AP.

20. The non-transitory computer-readable storage medium of claim 16, wherein to determine that the UE switched from using the first wireless frequency to using the second wireless frequency, the instructions are further operable to cause the one or more processor devices to:
iteratively:
obtain wireless frequency information from the UE that corresponds to a wireless frequency that the UE is using to wirelessly communicate with any AP; and
determine that the wireless frequency that the UE is using to wirelessly communicate with any AP is different from a wireless frequency that the UE was using to wirelessly communicate with any AP in an immediately preceding iteration.
